(19) United States
(12) Patent Application Publication
(10) Pub. No.: US 2012/0231674 A1
(43) Pub. Date: Sep. 13, 2012

(54) Improvements to Plugs and/or Sockets

(76) Inventor: William G. Dolman, Shouldham Norfolk (GB)

(21) Appl. No.: 13/383,404

(22) PCT Filed: Jun. 29, 2010
(86) PCT No.: PCT/GB2010/051065

§ 371 Date: Apr. 26, 2012

(30) Foreign Application Priority Data
Jul. 10, 2009 (GB) 0912052.4

(51) Int. Cl. H01R 24/76

(52) U.S. Cl. 439/676

(57) ABSTRACT

A socket comprises a plurality of recesses with electrically conductive contacts; said recesses being configured to receive the prongs of a corresponding plug; and a plug housing recess for receiving at least a portion of the housing of a plug; wherein said plug housing recess incorporates an engagement surface against which said plug engages in order to pivot between an initial position where the prongs are positioned to enter the recesses and a position where the prongs are fully engaged within the recesses. A plug suitable for use with this socket is also presented.

### FIELD OF THE INVENTION

The invention relates to plugs and/or sockets.

### BACKGROUND TO THE INVENTION AND PRIOR ART KNOWN TO THE APPLICANT

In a standard United Kingdom plug and socket arrangement, the plug usually takes the form of a housing with a plurality of protruding electrically conductive prongs. The electrically conductive prongs protrude perpendicularly from the lower surface of the plug. The housing is usually made of two parts with the rear of the plug incorporating an aperture through which a power cable protrudes. The only external surface of engagement between this kind of plug and the traditional socket is the lower surface surrounding the prongs. Due to the electrically conductive contacts located in the socket and often the presence of flaps covering the apertures, inserting a plug into a socket requires considerable force. The operator usually grabs the sides of the plug and pulls it away from the socket. The plug is inserted and extracted in the direction perpendicular to the top surface of the socket. Removal of the plug also requires considerable force. Despite the plug being relatively secure when fully engaged in the socket, a sharp pull on the power cable is often enough to inadvertently remove the plug from its fully engaged position.

Furthermore, the sockets often incorporate a mechanically actuated exposed switch which operates entirely separately from the plug which requires the switch to be actuated separately from the insertion of the plug into the socket. This would therefore require a level of operator knowledge to ensure that the plug is connected in a manner to power the devices with which the plug is associated.

The invention seeks to address one or more of the following objectives:
Improve the manner in which a plug is inserted into a socket;
Allow the secure insertion of the plug into a socket without necessarily having to handle the housing of the plug;
Allow the plug to actuate the socket as part of the insertion process;
Allow the plug to switch off the socket as part of the removal of the plug process;
Reduce the force required for the insertion and removal of a plug whilst increasing the amount by which a plug is secured to a socket; and
Further improve the safety of handling a plug and socket arrangement.

### SUMMARY OF THE INVENTION

In a first broad independent aspect, the invention provides a socket comprising a plurality of recesses with electrically conductive contacts; said recesses being configured to receive the prongs of a corresponding plug; and a plug housing recess for receiving at least a portion of the housing of a plug; wherein said plug housing recess incorporates an engagement surface against which said plug engages in order to pivot between an initial position where the prongs are positioned to enter the recesses and a position where the prongs are fully engaged with the recesses. This configuration is particularly advantageous, because it improves how a plug is located relative to a socket. It allows a safer contact to be achieved between plug and socket. It also allows the plug to be secured to the socket in order to substantially limit the chances of a plug being inadvertently removed from a socket.

In a subsidiary aspect in accordance with the invention's first broad independent aspect, the engagement surface incorporates a part-cylindrical portion. This configuration is particularly advantageous in order to precisely guide and locate the pivoting action of the plug relative to the socket.

In a further subsidiary aspect, a further recess is provided beneath said part-cylindrical portion; said further recess being shaped and configured to receive a corresponding projection of a plug. This further improves the location properties of a plug relative to a socket.

In a further subsidiary aspect, said plurality of recesses for receiving the prongs of a corresponding plug are shaped and configured to receive curved prongs. This configuration is particularly advantageous in order to facilitate the pivoting of a plug relative to a socket during its engagement.

In a further subsidiary aspect, said socket further comprises a switch with an OFF position and an ON position and an actuator which acts or is acted upon when a plug engages said socket; whereby said switch is changeable or changes from an OFF position to an ON position. This ensures that when the plug is removed from the socket, the socket is in a switched off mode of operation which therefore provides a safe socket.

In a further subsidiary aspect, said actuator takes the form of a lever. This allows a mechanical contact between a plug and a socket so as to act upon the switch in an improved manner. Optionally, the insertion of the plug may remove a bar which would otherwise prohibit the switch from being switched on when the plug is not in. When the plug is inserted into the socket, the bar may be removed allowing an operator to manually operate the switch.

In a further subsidiary aspect, said lever is configured to pivot in abutment against said socket. This further improves the control of the switch by allowing the process of engagement of the plug with the socket to actuate the switch.

In a further subsidiary aspect, said plug housing recess increases in depth from one side of the recess to its opposite side corresponding to said engagement surface. This further emphasises the direction of necessary engagement so that the operator finds no difficulty in locating the plug in the socket and then causing the plug to contact the socket. It also further emphasises the directional nature of the contact between plug and socket which would further improve the operator's ability to correctly position the plug relative to the socket.

In a second broad independent aspect, the invention provides a plug suitable for use with the socket of any of the preceding aspects, comprising a housing and a plurality of protruding electrically conductive prongs; said housing having an abutment surface shaped and configured to engage the engagement surface of a corresponding socket; whereby said plug pivots between an initial position where the prongs are positioned to enter the recesses of a socket and a position where the prongs are fully engaged with the recesses.

This configuration improves the relative location of a plug and a socket. It simplifies the process of insertion and removal of a plug.

In a subsidiary aspect in accordance with the invention's second broad aspect, said abutment surface incorporates a part-cylindrical portion. This allows the plug to engage the socket and pivot in an improved manner.

In a further subsidiary aspect, said abutment surface incorporates a projection. This allows the plug to be more readily located relative to the recess of a socket.

In a further subsidiary aspect, said plug is configured to cause the actuator of a corresponding socket to switch or allow the switching from an OFF position to an ON position when a plug engages a socket. This simplifies the operation of switching ON and OFF a socket. The socket may be equipped with means allowing the switch to return to its OFF position when an operator removes the plug.

In a further subsidiary aspect, said plug incorporates a recess configured to engage the lever of a socket. This configuration ensures an improved actuation of the switch. In a further subsidiary aspect, said prongs are curved. This configuration allows the prongs to be readily inserted into the recesses and accommodates the pivoting action of the plug relative to the socket. In a further subsidiary aspect, said plug incorporates a handle projecting in the direction of a power cable which, in use, is fitted to said plug. This configuration is particularly advantageous because it allows an operator to simply lift the plug upwards to remove the socket from its engagement. It also allows the operator to handle the plug if required in an improved manner. It also adds leverage in both the insertion and removal process.

### BRIEF DESCRIPTION OF THE FIGURES

FIG. 1 shows a perspective view of a plug and socket arrangement.

FIG. 2 shows a side elevation of a plug and socket arrangement.

### DETAILED DESCRIPTION OF THE FIGURES

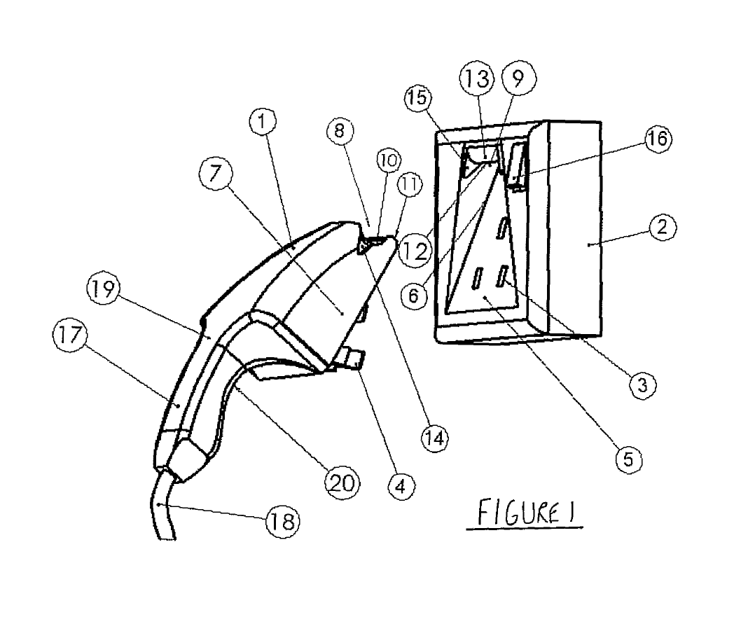

FIG. 1 shows a plug 1 and a socket 2. The socket incorporates a number of recesses such as recess 3 into which electrically conductive prongs 4 are inserted. The prong 4 may be entirely electrically conducted or only partially. As shown in FIG. 1 the distal extremity of the prong 4 is electrically conductive. Recesses 3 incorporate electrically conductive contacts and shutters of a standard kind. Surface 5 which surrounds the upper portion of the recesses 3 slopes downwards. Recess 6 corresponds in size to a portion of the housing 7 of socket 1. An abutment surface 8 is provided at the forward most portion of the plug. The upper abutment surface 8 corresponds in shape and configuration to the engagement surface generally referenced 9 provided in recess 6 of socket 2. Abutment surface 8 incorporates a part cylindrical portion 10 and beneath the part cylindrical portion 10 a projection incorporating a radiused portion at its distal extremity. Projection 11 locates into recess 12 located beneath part cylindrical portion 13 of the engagement surface 9.

The forward most portion of the plug also incorporates two lateral indentations 14 which correspond to levers 15. Lever 15 acts on mechanical switch 16 whereby as the plug is pivoted from a position of initial engagement to a fully engaged position, the switch passes from an OFF position to an ON position. Alternatively, the lever 15 unblocks mechanical switch 16 in order to allow its manual operation. In either of these embodiments, the mechanical switch 16 may incorporate a spring to cause the switch to return to an OFF position as the plug is removed.

The invention envisages the use of further actuators for switching the socket between an OFF position and an ON position. The actuator may take the form of a magnetic actuator; whereby when a magnet and/or a ferrous component is provided as part of the plug, the switching is achieved as the plug is located in sufficient proximity to cause the magnetic actuator to effect the switching of the socket. Other forms of proximity actuators of this kind may be used.

Plug 1 also incorporates at its rear a handle 17 which projects in the direction of a power cable 18. The handle 17 incorporates a convex or bowed upper surface 19 and a concave or bowed lower surface 20. The handle is shaped ergonomically to facilitate the operator's grip. Prongs 4 are curved in a forward direction. Each prong extends in the same direction in order to facilitate ready insertion of the prongs into the recesses.

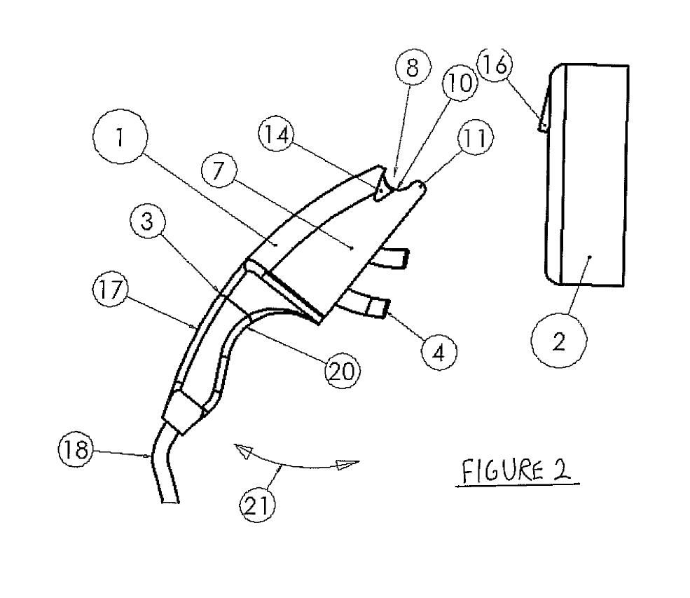

FIG. 2 shows the components of FIG. 1 from a different angle. Identical numerical references have been used for clarity. The cylindrical abutment surface 8 can be readily observed in this illustration. Arrow 21 has been added to illustrate the direction of rotation once the engagement surface and the abutment surface are in contact with one another. In the preceding embodiments, the socket incorporates a projecting part-cylindrical portion whilst the plug incorporates a recessed part-cylindrical portion. The invention envisages alternatively that the socket may incorporate the recess whilst the plug incorporates the part-cylindrical projection.

1-16. (canceled)

17. A socket comprising:
a plurality of recesses with electrically conductive contacts, said recesses being configured to receive the prongs of a corresponding plug; and
a plug housing recess for receiving at least a portion of the housing of a plug,
wherein said plug housing recess incorporates an engagement surface against which said plug engages in order to pivot between an initial position where the prongs are positioned to enter the recesses and a position where the prongs are fully engaged with the recesses.

18. A socket according to claim 17, wherein said engagement surface incorporates a part-cylindrical portion.

19. A socket according to claim 17, wherein a further recess is provided beneath said part-cylindrical portion; said further recess being shaped and configured to receive a corresponding projection of said plug.

20. A socket according to claim 17, wherein said plurality of recesses for receiving the prongs of a corresponding plug are shaped and configured to receive curved prongs.

21. A socket according to claim 17, wherein said socket further comprises a switch with an OFF position and an ON position; and an actuator which acts when a plug engages said socket;
whereby said switch changes from an OFF position to an ON position.

22. A socket according to claim 21, wherein said actuator takes the form of a lever.

23. A socket according to claim 22, wherein said lever is configured to pivot in abutment against said socket.

24. A socket according to claim 17, wherein said plug housing recess increases in depth from one side of the recess to an opposite side of the recess corresponding to said engagement surface.

25. A plug suitable for use with the socket of claim 17, comprising:
a housing; and
a plurality of protruding electrically conductive prongs; said housing having an abutment surface shaped and configured to engage the engagement surface of a corresponding socket;
whereby said plug pivots between an initial position where the prongs are positioned to enter the recesses of a socket and a position where the prongs are fully engaged with the recesses.

26. A plug according to claim 25, wherein said abutment surface incorporates a part-cylindrical portion.

27. A plug according to claim 25, wherein said abutment surface incorporates a projection.

28. A plug according to claim 25, wherein said plug is configured to cause an actuator of a corresponding socket to switch or to allow its switching from an OFF position to an ON position when a plug engages a socket.

29. A plug according to claim 28, wherein said plug incorporates a recess configured to engage a lever of a socket.

30. A plug according to claim 25, wherein said prongs are curved.

31. A plug according to claim 25, wherein said plug incorporates a handle projecting in a direction of a power cable which, in use, is fitted to said plug.

32. A plug according to claim 25, wherein said plug is configured to cause an actuator of a corresponding socket to allow its switching from an OFF position to an ON position when a plug engages a socket.

33. A socket according to claim 17, wherein said socket further comprises a switch with an OFF position and an ON position; and an actuator is acted upon when a plug engages said socket;
whereby said switch is changeable from an OFF position to an ON position.
